(19) United States
(12) Patent Application Publication
(10) Pub. No.: US 2011/0273245 A1
(43) Pub. Date: Nov. 10, 2011

(54) PRINTED CIRCUIT BOARD AND COMMON MODE FILTER THEREOF

(75) Inventors: YU-CHANG PAI, Tu-Cheng (TW); CHIEN-HUNG LIU, Tu-Cheng (TW); PO-CHUAN HSIEH, Tu-Cheng (TW)

(73) Assignee: HON HAI PRECISION INDUSTRY CO., LTD., Tu-Cheng (TW)

(21) Appl. No.: 12/775,500

(22) Filed: May 7, 2010

(30) Foreign Application Priority Data
May 4, 2010 (TW) 99114152

(51) Int. Cl. H01P 1/203

(52) U.S. Cl. 333/204

(57) ABSTRACT

A printed circuit board includes a signal layer and a ground layer adjacent to the signal layer. The signal layer includes a pair of differential transmitting lines. The ground layer includes a common mode filter formed by hollowing patterns on the ground layer. The common mode filter includes two filter portions respectively arranged at opposite sides of a projection of the pair of differential transmitting lines on the ground layer. Each of the two filter portions includes a number of long narrow parallel strips connected in a snake like pattern. Hollowed areas of the two filter portions are bridged through a void.

### BACKGROUND

1. Technical Field

The present disclosure relates to a printed circuit board and a common mode filter of the printed circuit board.

2. Description of Related Art

Nowadays, many printed circuit boards include differential signal lines arranged in signal layers of the printed circuit boards. To avoid common mode signals being transmitted through the differential signal lines, some common mode filters are connected to the differential signal lines to filter the common mode signals. However, these common mode filters will occupy some space of the printed circuit boards and thus increase the costs.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of a printed circuit board, in accordance with an embodiment, the printed circuit board including a common mode filter.

FIG. 2 is an assembled, isometric view of the printed circuit board of FIG. 1.

FIG. 3 is a simulation graph of insertion loss of the common mode filter of the printed circuit of FIG. 1.

### DETAILED DESCRIPTION

The disclosure is illustrated by way of example and not by way of limitation in the figures of the accompanying drawing in which like references indicate similar elements. It should be noted that references to “an” or “one” embodiment in this disclosure are not necessarily to the same embodiment, and such references mean at least one.

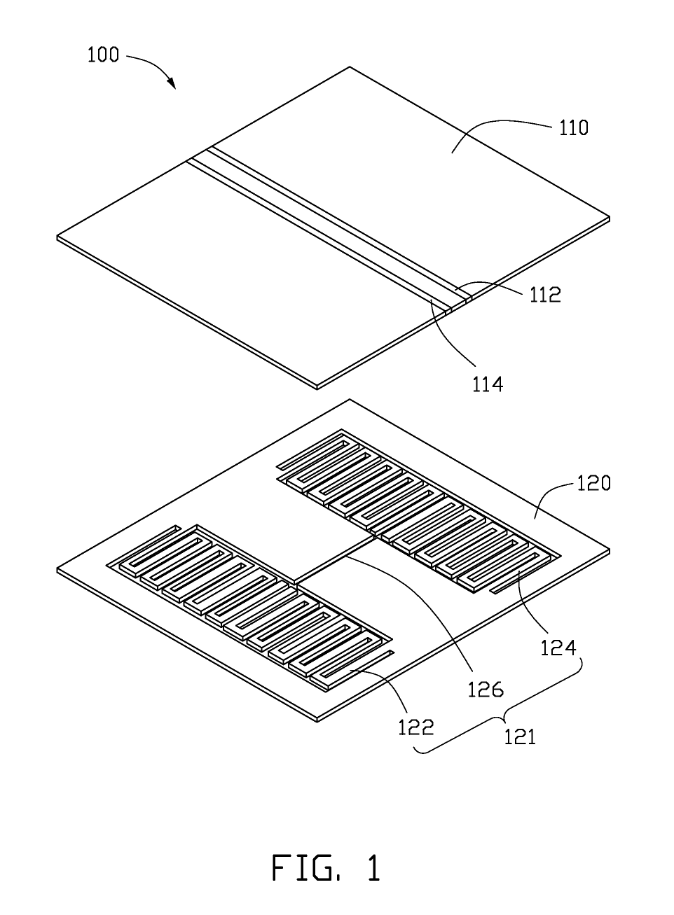

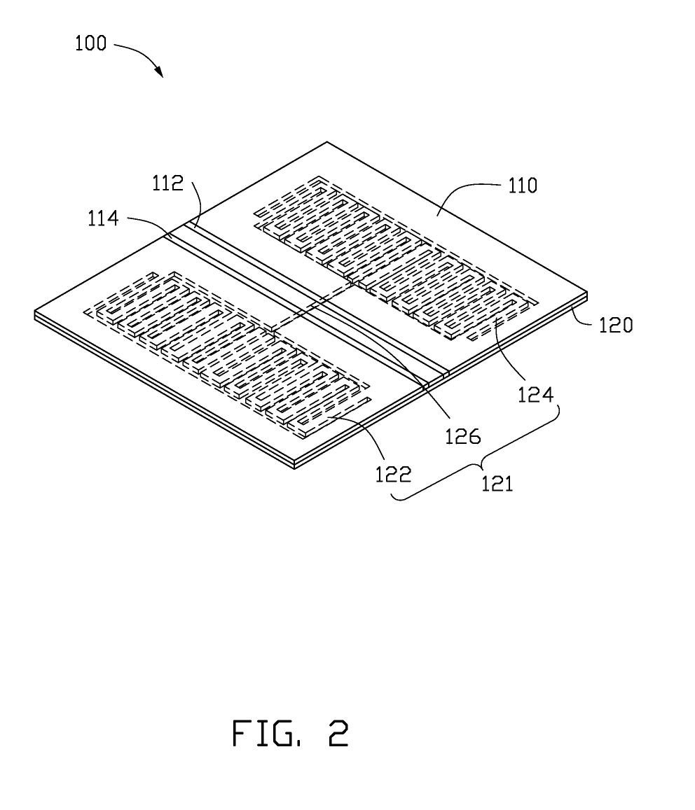

Referring to FIGS. 1 and 2, an embodiment of a printed circuit board (PCB) 100 includes a signal layer 110 and a ground layer 120 adjacent to and below the signal layer 110. The signal layer 110 includes a pair of differential transmitting lines 112 and 114. It may be understood that the PCB 100 also includes other layers, such as a power layer, for example. These other layers fall within well-known technologies, and are therefore not described here.

To avoid some common mode signals being transmitted through the pair of differential transmitting lines 112 and 114, the ground layer 120 is hollowed at some special positions to form a common mode filter 121. The common mode filter 121 includes two filter portions 122 and 124, the hollowed areas of the two filter portions 122 and 124 are bridged through an elongated void 126.

The two filter portions 122 and 124 are respectively arranged at opposite sides of a projection of the pair of differential transmitting lines 112 and 114 on the ground layer 120. The shape of each of the filter portions 122 and 124 is generally rectangular, and the long sides of each of the rectangles are parallel with the pair of differential transmitting lines 112 and 114. Each of the filter portions 122 and 124 includes a plurality of long narrow strips perpendicular to the pair of differential transmitting lines 112 and 114 and connected in a snake like pattern. In one embodiment, the elongated void 126 is vertical to the pair of differential transmitting lines 112 and 114. For common mode signals transmitted over the pair of differential transmitting lines 112 and 114, because the frame of the filter portions 122 and 124 can result in resonance of inductors and capacitors, the common mode signals will not easily pass through the pair of differential transmitting lines 112 and 114. Therefore, the common mode filter 121 can effectively prevent common mode signals from passing through the pair of differential transmitting lines 112 and 114.

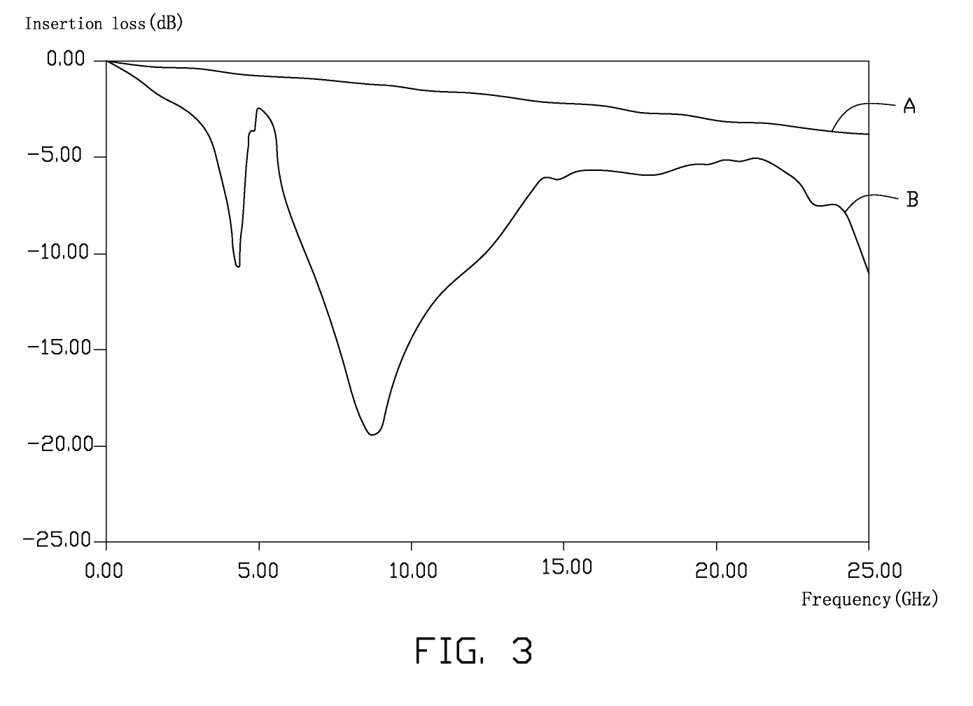

Referring to FIG. 3, the curve A indicates insertion loss when differential signals are transmitted though the common mode filter 121, and the curve B indicates insertion loss when common mode signals are transmitted though the common mode filter 121. Obviously, the differential signals are almost entirely transmitted though the common mode filter 121, but the common mode signals are effectively filtered, especially at a special frequency range, such as 8-9 gigahertzs (GHz). In other embodiments, the frequency range can be adjusted by changing some parameters, such as the number and/or width of the long narrow strips.

The PCB 100 doesn't use any common mode filters arranged on the PCB 100, therefore the PCB 100 can save some space and cost.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A printed circuit board comprising:
a signal layer comprising a pair of differential transmitting lines; and
a ground layer adjacent to and below the signal layer, the ground layer comprising a common mode filter formed by hollowing the ground layer, the common mode filter comprising two filter portions respectively arranged at opposite sides of a projection of the pair of differential transmitting lines in the ground layer; wherein each of the two filter portions includes a plurality of long narrow strips perpendicular to the pair of differential transmitting lines and connected in a snake like pattern, wherein hollowed areas around the two filter portions are bridged through a void.

2. The printed circuit board of claim 1, wherein a shape of each of the two filter portions is about rectangular, and long sides of the shape are parallel with the pair of differential transmitting lines.

3. The printed circuit board of claim 2, wherein the void is elongated and vertical to the pair of differential transmitting lines.

4. A common mode filter for filtering common mode signals transmitted through a pair of differential transmitting lines of a signal layer of a printed circuit board (PCB), the PCB further comprising a ground layer adjacent to the signal layer, the common mode filter comprising:
two filter portions respectively arranged on the ground layer and at opposite sides of a projection of the pair of differential transmitting lines on the ground layer;
wherein each of the two filter portions includes a plurality of long narrow parallel strips connected in a snake like pattern, hollowed areas of the two filter portions are bridged through a void.

5. The common mode filter of claim 4, wherein a shape of each of the two filter portions is about rectangular, and long sides of the shape are parallel with the pair of differential transmitting lines.

6. The common mode filter of claim 5, wherein the void is vertical with the pair of differential transmitting lines.
